(19) United States
(12) Patent Application Publication
(10) Pub. No.: US 2010/0114901 A1
(43) Pub. Date: May 6, 2010

(54) COMPUTER-READABLE RECORDING MEDIUM, CONTENT PROVIDING APPARATUS COLLECTING USER-RELATED INFORMATION, CONTENT PROVIDING METHOD, USER-RELATED INFORMATION PROVIDING METHOD AND CONTENT SEARCHING METHOD

(76) Inventors: Young-ho RHEE, Seoul (KR); Hyun-joo Kang, Suwon-si (KR); Yeo-jin Kim, Suwon-si (KR); Il-ku Chang, Seoul (KR); Ju-youn Lee, Seongnam-si (KR)

Correspondence Address: North Star Intellectual Property Law, PC, P.O. Box 34688, Washington, DC, 20043, US

(21) Appl. No.: 12/610,454

(22) Filed: Nov. 2, 2009

(30) Foreign Application Priority Data
Nov. 3, 2008 (KR) 10-2008-0108263

(51) Int. Cl. G06F 17/30

(52) U.S. Cl. 707/741; 707/792; 707/769; 707/E17.002; 707/E17.044; 707/E17.014

(57) ABSTRACT

Content providing and searching technology provides content capable of collecting user-related information for searching to which a user's intention is reflected, and collects user-related information from user devices that receive the content. By providing user-related information to user devices, it may be possible to process various user-related events. Moreover, since searching to which a user's intention is reflected may be possible, the user may easily search for desired content.

### CROSS-REFERENCE TO RELATED APPLICATION

This application claims the benefit under 35 U.S.C. §119(a) of a Korean Patent Application No. 10-2008-108263, filed Nov. 3, 2008, the entire disclosure of which is incorporated herein by reference for all purposes.

### BACKGROUND

1. Field

The following description relates to content providing technology, and more particularly, to a computer-readable recording medium storing content, a content providing apparatus that collects user-related information, a content providing method, a user-related information providing method and a content searching method.

2. Description of the Related Art

Content may be distributed which contain metadata. Metadata is static information about content, such as, but not limited to, a creation time, resolution, and/or quality of the content. The content is referred to by a content reproduction module, for example, a browser. Such metadata is executed by a user device.

Technology to search content with reference to metadata included in the content has been developed. While this technology may allow content-based searching, it does not allow user-based searching. User based searching may be described as searching to which a user's intention is reflected.

### SUMMARY

In one general aspect, there is provided a computer-readable recording medium storing content, the content including content-related information, index information for matching user-related information, and content data.

The index information may include at least one of a first index information for matching user identification information, a second index information for matching user activity information, a third index information for matching user emotion information, a fourth index information for matching user location information and a fifth index information for matching user preference information.

In another general aspect, there is provided a content providing apparatus configured to collect user-related information, including a content provider to provide content including content-related information, index information for matching user-related information, and content data, a user-related information collector to collect the user-related information from a plurality of user devices which receive the content provided by the content provider, a user-related information storage to store the user-related information collected by the user-related information collector in a location of a database indicated by the index information.

The index information may include at least one of a first index information for matching user identification information, a second index information for matching user activity information, a third index information for matching user emotion information, a fourth index information for matching user location information and a fifth index information for matching user preference information.

The user-related information collector may detect user identification information corresponding to a user device which receives the content provided by the content provider.

The user identification information may be an IP address of the user device or an ID of the user.

The user-related information collector may provide a user interface to allow a user device which receives the content provided by the content provider to input user activity information, and receive the user activity information from the user through the user interface.

The user-related information collector may provide a user interface to allow a user device which receives the content provided by the content provider to input user emotion information, and receive the user emotion information from the user through the user interface.

The user-related information collector may detect, as user location information, location information of a user device which receives the content provided by the content provider.

The user-related information collector may provide a user interface to allow a user device which receives content provided by the content provider to input user location information, and receive the user location information from the user through the user interface.

The user-related information collector may provide a user interface to allow a user is device which receives content provided by the content provider to input user preference information, and receive the user preference information from the user through the user interface.

The content providing apparatus may further include a user-related information provider to search for user-related information in the database and provide the searched user-related information to the user device when an event is generated from the user device.

The event may be a user-related information request for outputting a list of users that use the content currently.

The event may be a user-related information request for displaying states of users that use the content currently.

The event may be a user-related information request for forming a community between users that use the content currently.

The content providing apparatus may further include a content searching unit to search for content corresponding to specific user-related information in the database and provide a list of the searched content to the user device when a request for searching for the content corresponding to the specific user-related information is received from the user device.

In still another general aspect, there is provided a content providing method including providing content including content-related information, index information for matching user-related information, and content data, collecting user-related information from a plurality of user devices that receive the provided content, and storing the collected user-related information in locations of a database indicated by the index information.

The index information may include at least one of a first index information for matching user identification information, a second index information for matching user activity information, a third index information for matching user emotion information, a fourth index information for matching user location information and a fifth index information for matching user preference information.

In yet another general aspect, there is provided a user-related information providing method including searching for user-related information corresponding to the content in a database when an event is generated from a user device that receives content including content-related information, index information for matching user-related information, and content data, and providing the searched user-related information to the user device.

In yet still another general aspect, there is provided a content searching method including searching for the content corresponding to the specific user-related information in a database in which content-related information and user-related information are stored for each content when a request for searching for content corresponding to specific user-related information is received from a user device, and providing a list of the searched content to the user device.

Other features and aspects will be apparent from the following description, the drawings, and the claims.

### BRIEF DESCRIPTION OF THE DRAWINGS

FIG. 1 is a diagram illustrating an exemplary content structure.

FIG. 2 is a diagram illustrating an exemplary content providing apparatus to collect user-related information.

FIG. 3 is a flowchart illustrating an exemplary content providing method.

FIG. 4 is a flowchart illustrating an exemplary user-related information providing method.

FIG. 5 is a flowchart illustrating an exemplary content searching method.

FIG. 6 shows an exemplary user-related information table.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly various changes, modifications, and equivalents of the systems, apparatuses, and/or methods described herein will be suggested to those of ordinary skill in the art. Also, descriptions of well-known functions and constructions may be omitted to increase clarity and conciseness.

Content-related information, or metadata, includes static information which is unique to content. Examples of content-related information may include a creation time, resolution, and/or quality of the content.

User-related information includes dynamic information which is specific to users that use content. Examples of user-related information may include user identification information, user activity information, user emotion information, user location information, and user preference information.

Index information for matching user-related information includes information indicating a location at which user-related information is stored. User-related information may be collected from a plurality of users that receive the content.

A content providing apparatus includes a server which may provide contents containing content-related information, index information for matching user-related information, and content data to a plurality of user devices.

A user device includes a client device which may receive and reproduce content containing content-related information, index information for matching user-related information, and content data, which are provided by a content providing apparatus. The user device may be a device with a network function or content reproduction function, such as a mobile phone, a set-top box for IPTV, a MP3 player, a PMP and the like.

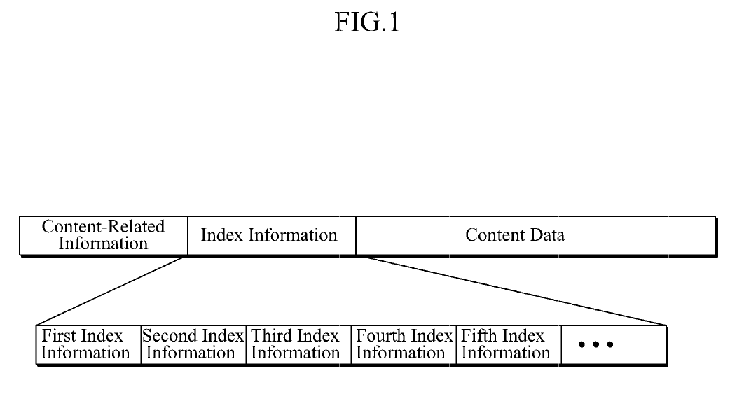

FIG. 1 illustrates an exemplary content structure. As illustrated in FIG. 1, the content includes content-related information, index information for matching user-related information, and content data. The content may be stored in a computer-readable recording medium such as, but not limited to, a disk.

The content data may be real data constructing the content, and may be provided to a plurality of user devices by a content providing apparatus (will be described later) and then reproduced by each user device. As illustrated for exemplary purposes in FIG. 1, the index information is composed of a plurality of pieces of lower index information.

An example of first index information may be information for matching user identification information, such as an IP address of a user device which uses the content, an ID of a user who uses the content and the like. The user identification information may be detected and collected automatically by the content providing apparatus which will be described later.

An example of second index information may be information for matching user activity information indicating a current state of a user who uses the content, such as ‘studying’, ‘resting’, ‘eating’, etc. The user activity information may be received from a user device and collected by the content providing apparatus.

An example of third index information may be information for matching user emotion information indicating a current emotional state of a user who uses the content, such as ‘delight’, ‘pleasure’, ‘sadness’, ‘angry’, etc. The user emotion information may be input through a user device and collected by the content providing apparatus.

An example of fourth index information may be information for matching user location information indicating a current location of a user who uses the content. The user location information may be detected and collected automatically by the content providing apparatus, or received from a user device and collected by the content providing apparatus.

An example of fifth index information may be information for matching user preference information indicating a content preference of a user who uses the content, such as ‘very high’, ‘high’, ‘medium’, ‘low’, ‘very low’, etc. The user preference information may be received from a user device and collected by the content providing apparatus.

Dynamic information which is unique to each user may be adopted as user-related information and may be, for example, in the form of a table, stored in and managed by a database.

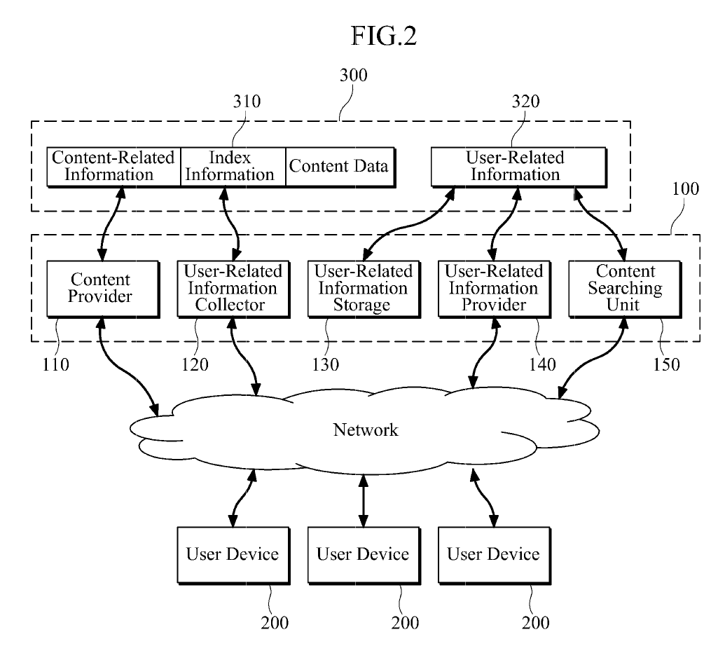

FIG. 2 illustrates an exemplary content providing apparatus 100 with a function of collecting user-related information. The content providing apparatus 100 includes a content provider 110, a user-related information collector 120 and a user-related information storage 130.

The content provider 110 provides content 310 including content-related information, index information for matching user-related information, and content data. The index information is information indicating storage locations of user-related information collected from a plurality of user devices that receive the content.

In one non-limiting example, the index information may be composed of information identifiers for identifying information, and a plurality of pieces of lower index information including table indexes for storing information. The types of the user-related information may be identified by the information identifiers, and the storage locations of the user-related information in a database 300 may be designated by the table indexes.

In an additional example, the index information may include first index information for matching user identification information, second index information for matching user activity information, third index information for matching user emotion information, fourth index information for matching user location information and fifth index information for matching user preference information. Since details about the index information have been described above, further descriptions thereof will be omitted.

The user-related information collector 120 may collect user-related information 320 from a plurality of user devices 200 which receive content provided by the content provider 110.

The user-related information collector 120 may collect, as user-related information, dynamic information which is unique to each user who uses the content, such as user identification information, user activity information, user emotion information, user location information, user preference information, etc. The following paragraphs describe various non-limiting examples of user-related information collected by the user-related information collector 120 and/or the methods by which the user-related information is collected. The collected user-related information and the method by which it is collected may be, but is not limited to, any one of, or combination of the following:

The user-related information collector 120 may collect user-related information by detecting user identification information corresponding to a user device 200 which receives content provided by the content provider 110. Here, the user identification information may be an IP address of the user device 200 or an ID of the corresponding user.

The user-related information collector 120 may collect user-related information by providing, to a user device 200 which has received content provided by the content provider 110, a user interface to input user activity information, and receiving user activity information through the user interface.

The user-related information collector 120 may collect user-related information by providing, to a user device 200 which has received content provided by the content provider 110, a user interface to input user emotion information, and receiving user emotion information through the user interface.

The user-related information collector 120 may collect user-related information by detecting, as user location information, location information of a user device 200 which has received content provided by the content provider 110. For example, the location information of the user device 200 may be detected by a GPS module of the user device 200.

The user-related information collector 120 may collect user-related information by providing, to a user device 200 which has received content provided by the content provider 110, a user interface to input the user's location information, and receiving the user's location information through the user interface.

The user-related information collector 120 may collect user-related information by providing, to a user device 200 which has received content provided by the content provider 110, a user interface to input user preference information, and receiving user preference information through the user interface.

The user-related information storage 130 may store the user-related information collected by the user-related information collector 120 in a location of the database 300 indicated by the index information.

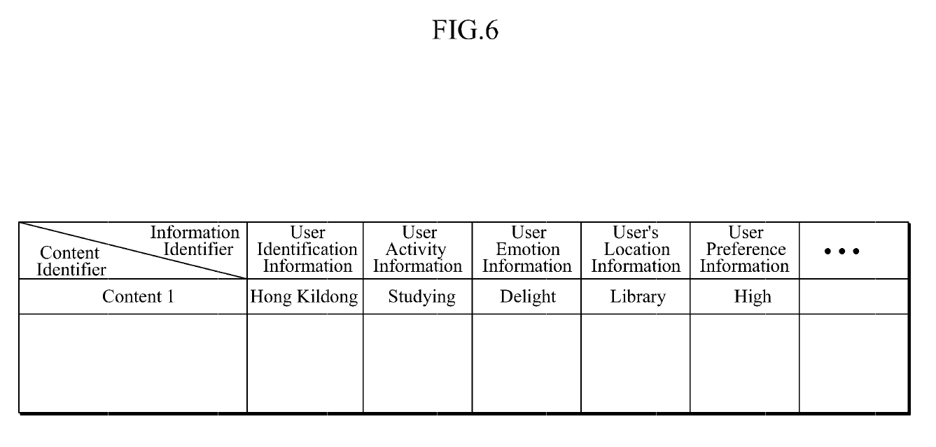

For example, the user-related information stored by the user-related storage 130 may be stored and managed in the form of a table, as illustrated in FIG. 6. FIG. 6 shows an exemplary user-related information table.

Referring to FIG. 6, pieces of user-related information of Content 1 identified by a content identifier are identified individually by information identifiers. Information identifiers may include user identification information, user activity information, user emotion information, user's location information, user preference information, etc. As an example, in the case of the Content 1, user identification information has been stored as ‘Hong Kildong’, user activity information has been stored as ‘studying’, user emotion information has been stored as ‘pleasure’, user's location information has been stored as ‘library’, and user preference information has been stored as ‘high’. In other words, it is possible to collect user-related information from a plurality of user devices and manage the user-related information for each content which is identified by a content identifier.

Accordingly, the content providing apparatus 100 of FIG. 2 may provide content capable of collecting user-related information for searching to which a user's intention is reflected, and collect user-related information from user devices that have received the content.

According to another aspect, the content providing apparatus 100 may further include a user-related information provider 140. The user-related information provider 140, when an event is generated from a user device 200, may search for corresponding user-related information in the database 300 and provide the searched user-related information to the user device 200. The event may be any one of, or combination of the following examples:

The event may be a user-related information request for outputting a list of users that are using the corresponding content currently. In this case, the user-related information provider 140 searches for users that are using the content currently, with reference to user identification information among the user-related information 320 stored in the database 300, and provides a list of the searched users to the user device that has issued the user-related information request. Then, the user device 200 outputs the list of the users that are using the corresponding content currently.

The event may be a user-related information request for displaying the states of users that are using the content currently. In this case, the user-related information provider 140 searches for the states of users that are using the content currently, with reference to user activity information among the user-related information 320 stored in the database 300, and provides information about the states of users to the user device that has issued the user-related information request. Then, the user device displays the states of the users that are using the content currently.

The event may be a user-related information request for creating a community between users that are using the content currently. In this case, the user-related information provider 140 searches for users that can participate in the community, with reference to user identification information and user activity information among the user-related information 320 stored in the database 300, and provides a list of the searched users to the user device that has issued the user-related information request. Then, the user device creates the community between the users that are using the content currently.

In this manner, since the content providing apparatus 100 provides user-related information to the user device 200, the user device can process various user-related events, such as outputting a list of users that are using the corresponding content currently, displaying the states of users that are using the content currently, or creating a community between users that are using the content currently.

According to another aspect, the content providing apparatus 100 may further include a content searching unit 150. The content searching unit 150, when receiving a request for searching for content corresponding to specific user-related information from a user device 200, searches for contents corresponding to the specific user-related information in the database 300, and provides a list of the searched contents to the user device 200.

For example, it may be assumed that a plurality of pieces of content including content-related information, index information for matching user-related information and content data are stored in the database 300.

In addition, referring to FIG. 6, it may be assumed that information with the highest frequency is set as representative information by analyzing user-related information in which information identifiers are accumulated.

Also, it may be assumed that the content providing apparatus 100 provides a user interface for content searching through the content searching unit 150 to the user device 200, and the user requests to search for content corresponding to user-related information in which user activity information is set as ‘resting’, user emotion information is set as ‘pleasure’ and user preference information is set as ‘very high’, through the user interface.

The content searching unit 150 may search for content identifiers corresponding to user activity information ‘resting’, user emotion information ‘pleasure’ and user preference information ‘very high’ in user-related information stored in the database 300, and provide a list of contents corresponding to the searched content identifiers to the user device 200.

Accordingly, since searching to which a user's intention is reflected is possible using user-related information accumulated by the content providing apparatus 100 with the function of collecting user-related information, the user may easily search for desired content.

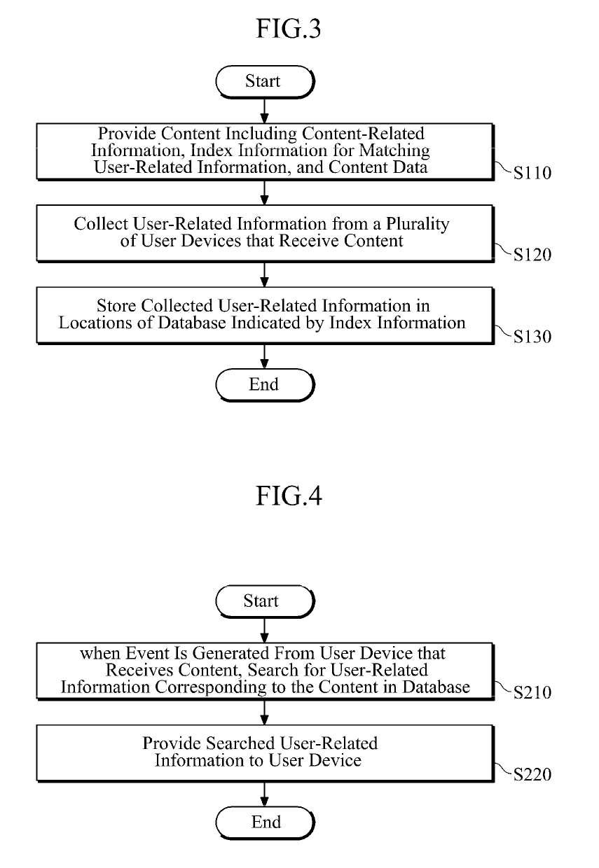

A method of providing content using a content providing apparatus with a function of collecting user-related information is described with reference to FIG. 3, below. FIG. 3 is a flowchart illustrating an exemplary content providing method.

The content providing apparatus may provide content including content-related information, index information for matching user-related information, and content data, to a plurality of user devices (operation S110).

The content providing apparatus may collect user-related information from the plurality of user devices that have received the content provided in operation S110 (operation S120).

The content providing apparatus may store the user-related information collected in operation S120 in locations of a database indicated by index information for matching user-related information, wherein the index information is included in the corresponding content (operation S130)

For example, the index information may include first index information for matching user identification information, second index information for matching user activity information, third index information for matching user emotion information, fourth index information for matching user location information and fifth index information for matching user preference information.

Accordingly, the content providing apparatus may provide content capable of collecting user-related information for searching to which a user's intention is reflected, and collect user-related information from user devices that have received the content.

A method of providing user-related information using a content providing apparatus with a function of collecting user-related information is described with reference to FIG. 4, below. FIG. 4 is a flowchart illustrating an exemplary user-related information providing method.

When an event is generated from a user device that has received content including content-related information, index information for matching user-related information and content data, the content providing apparatus may search for user-related information corresponding to the content in a database (operation S210).

The content providing apparatus may provide the searched user-related information to the user device (operation S220).

For example, the event may be a user-related information request for outputting a list of users that are using the content currently. In this case, in operation S210, users that are using the content are searched with reference to user identification information among user-related information stored in the database, and in operation S220, information about the searched users is provided to the corresponding user device. Then, the user device which receives the information about the users outputs a list of the users that are using the content currently.

For example, the event may be a user-related information request for displaying the states of users that are using the content currently. In this case, in operation S210, the states of users that are using the content currently are searched with reference to user activity information among user-related information stored in the database, and in operation S220, information about the states of the searched users is provided to the corresponding user device. Then, the user device displays the states of users that are using the content currently.

For example, the event may be a user-related information request for creating a community between users that are using the content currently. In this case, in operation S210, users that can participate in a community are searched with reference to user identification information and user activity information among user-related information stored in the database, and in operation S220, information about the searched users that can participate in creating the community is provided to the user device. Then, the user device creates the community between the users that are using the content currently.

Accordingly, in this way, since the content providing apparatus may provide user-related information to user devices, the user devices can process various user-related events, such as outputting a list of users that are using content currently, displaying the states of users that are using content currently or creating a community between users that are using content currently.

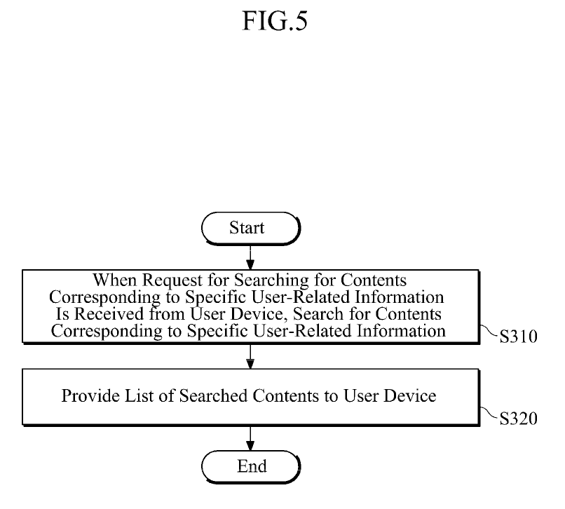

A method of searching for content using a content providing apparatus with a function of collecting user-related information is described with reference to FIG. 5. FIG. 5 is a flowchart illustrating an exemplary content searching method.

If the content providing apparatus provides a user interface for content searching to a user device, the user device may request to search for desired content by inputting user-related to information through the user interface.

When a request for searching for content corresponding to specific user-related information is received from a user device, the content providing apparatus may search for contents corresponding to the specific user-related information in a database which stores user-related information for each content (operation S310).

The content providing apparatus may provide a list of the searched contents to the user device (operation S320).

Accordingly, since by using user-related information accumulated by the content providing apparatus 100 with the function of collecting user-related information, searching to which a user's intention is reflected is possible, the user may search for desired content.

According to the exemplary embodiments described above, it is possible to provide content capable of collecting user-related information for searching to which a user's intention is reflected, and to collect user-related information from user devices that have received the content.

Also, by providing user-related information for searching to which a user's intention is reflected to a user device, it is possible to process various user-related events, such as outputting a list of users that are using content currently, displaying the states of users that are using content currently or creating a community between users that are using content currently.

Furthermore, searching to which a user's intention is reflected can be performed by using accumulated user-related information.

The methods described above may be recorded, stored, or fixed in one or more computer-readable recording media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable recording medium may be distributed among computer systems connected through a network and computer-readable codes or program instructions may be stored and executed in a decentralized manner.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A computer-readable recording medium storing content, the content comprising:
content-related information;
index information for matching user-related information; and
content data.

2. The computer-readable recording medium of claim 1, wherein the index information comprises at least one of a first index information for matching user identification information, a second index information for matching user activity information, a third index information for matching user emotion information, a fourth index information for matching user location information and a fifth index information for matching user preference information.

3. A content providing apparatus configured to collect user-related information, comprising:
a content provider to provide content including content-related information, index information for matching user-related information, and content data;
a user-related information collector to collect the user-related information from a plurality of user devices which receive the content provided by the content provider;
a user-related information storage to store the user-related information collected by the user-related information collector in a location of a database indicated by the index information.

4. The content providing apparatus of claim 3, wherein the index information comprises at least one of a first index information for matching user identification information, a second index information for matching user activity information, a third index information for matching user emotion information, a fourth index information for matching user location information and a fifth index information for matching user preference information.

5. The content providing apparatus of claim 4, wherein the user-related information collector detects user identification information corresponding to a user device which receives the content provided by the content provider.

6. The content providing apparatus of claim 5, wherein the user identification information is an IP address of the user device or an ID of the user.

7. The content providing apparatus of claim 4, wherein the user-related information collector provides a user interface to allow a user device which receives the content provided by the content provider to input user activity information, and receives the user activity information from the user through the user interface.

8. The content providing apparatus of claim 4, wherein the user-related information collector provides a user interface to allow a user device which receives the content provided by the content provider to input user emotion information, and receives the user emotion information from the user through the user interface.

9. The content providing apparatus of claim 4, wherein the user-related information collector detects, as user location information, location information of a user device which receives the content provided by the content provider.

10. The content providing apparatus of claim 4, wherein the user-related information collector provides a user interface to allow a user device which receives content provided by the content provider to input user location information, and receives the user location information from the user through the user interface.

11. The content providing apparatus of claim 4, wherein the user-related information collector provides a user interface to allow a user device which receives content provided by the content provider to input user preference information, and receives the user preference information from the user through the user interface.

12. The content providing apparatus of claim 3, further comprising a user-related information provider to search for user-related information in the database and provide the searched user-related information to the user device when an event is generated from the user device.

13. The content providing apparatus of claim 12, wherein the event is a user-related information request for outputting a list of users that use the content currently.

14. The content providing apparatus of claim 12, wherein the event is a user-related information request for displaying states of users that use the content currently.

15. The content providing apparatus of claim 12, wherein the event is a user-related information request for forming a community between users that use the content currently.

16. The content providing apparatus of claim 3, further comprising a content searching unit to search for content corresponding to specific user-related information in the database and provide a list of the searched content to the user device when a request for searching for the content corresponding to the specific user-related information is received from the user device.

17. A content providing method comprising:
providing content including content-related information, index information for matching user-related information, and content data;
collecting user-related information from a plurality of user devices that receive the provided content; and
storing the collected user-related information in locations of a database indicated by the index information.

18. The content providing method of claim 17, wherein the index information comprises at least one of a first index information for matching user identification formation, a second index information for matching user activity information, a third index information for matching user emotion information, a fourth index information for matching user location information and a fifth index information for matching user preference information.

19. A user-related information providing method comprising:
searching for user-related information corresponding to the content in a database when an event is generated from a user device that receives content including content-related information, index information for matching user-related information, and content data; and
providing the searched user-related information to the user device.

20. A content searching method comprising:
searching for the content corresponding to the specific user-related information in a database in which content-related information and user-related information are stored for each content when a request for searching for content corresponding to specific user-related information is received from a user device; and
providing a list of the searched content to the user device.
